(19) United States
(12) Patent Application Publication
(10) Pub. No.: US 2019/0365517 A1
(43) Pub. Date: Dec. 5, 2019

(54) RETRACTION INSTRUMENT FOR ORAL SURGERY HAVING INTEGRAL SUCTION MODULATOR

(71) Applicant: Michael D. DeGould, Rockford, IL (US)

(72) Inventor: Michael D. DeGould, Rockford, IL (US)

(21) Appl. No.: 16/418,491

(22) Filed: May 21, 2019

Related U.S. Application Data
(60) Provisional application No. 62/677,558, filed on May 29, 2018.

(51) Int. Cl. A61C 17/10; A61C 17/08; A61C 17/12

(52) U.S. Cl. CPC A61C 17/10; A61C 17/13; A61C 17/08

(57) ABSTRACT

Embodiments of an instrument for retraction and suction during performance of an oral procedure are disclosed herein. In general, the instrument is profiled so as to operate as a retractor during use. Further, the instrument has a central passage and an end configured for attachment to a suction device. In this way, the instrument operates to provide suction for removal of, e.g., bone slurry, blood, saliva, debris, and irrigant, during an oral procedure. The suction is modulated using a port that remains uncovered when suction is not desired and that is covered by a user's finger when suction is desired.

### CROSS REFERENCE TO RELATED PATENT APPLICATIONS

This application claims the benefit of priority to U.S. Provisional Application No. 62/677,558, filed May 29, 2018, which is incorporated herein by reference in its entireties.

### FIELD OF THE INVENTION

This invention generally relates to a medical instrument and more particularly to an instrument for use in oral procedures.

### BACKGROUND OF THE INVENTION

When oral surgery is being performed in a patient's mouth, it is necessary that the working area of the mouth be kept free of fluids and debris. These fluids may include saliva, blood, liquid used with drilling, and/or rinsing liquids, and the debris may be drilling dust and/or broken pieces of teeth. It is important for the patient's comfort to keep fluids from accumulating in the patient's mouth so that the fluids and debris are not swallowed and the patient can, if necessary, breath through his or her mouth.

Suction devices are used to keep the oral surgery work area clean and the patient's mouth relatively clear of fluids and debris. Such suction devices typically comprise a suction tube, which is connected to a long flexible hose, which is, in turn, connected to a vacuum source. When an oral surgeon is working on a tooth, an assistant is often required to manipulate the suction tube so as to maintain a clean work area and enable good visibility for the oral surgeon of the tooth being worked on. This procedure is problematic in that the assistant may be unable to anticipate the oral surgeon's moves in the patient's mouth and may thus be unable to keep the end of the suction tube out of the oral surgeon's way. As a consequence, the oral surgeon may prefer to do the evacuation of fluids and debris from the patient's mouth himself or herself.

During oral surgery, it is usually also necessary for the oral surgeon to use a retractor to push or pull soft tissue regions of the patient's mouth away from the work area. This may be necessary to provide a more unrestricted view of the work area. However, problems can result when both tissue retraction and fluid evacuation are needed. For example, the working area of a patient's mouth may become crowded with dental implements to an extent that the oral surgeon's task becomes very difficult to perform. Moreover, it may be necessary for the oral surgeon to frequently and repeatedly shift between tissue retraction and fluid evacuation implements, thereby requiring a longer time for the surgery being performed.

The invention provides an instrument that addresses an oral surgeon's needs for both a retractor device and a suction device while also having a minimal profile to avoid over-crowding in the patient's mouth. These and other advantages of the invention, as well as additional inventive features, will be apparent from the description of the invention provided herein.

### BRIEF SUMMARY OF THE INVENTION

Disclosed herein are embodiments of an instrument that operates as a retractor and as a suction nozzle for use during an oral procedure. In brief, the instrument is hollow so that fluid and debris are able to be sucked through the instrument to evacuate such fluid and debris from the patient's mouth. Further, the suction end of the device includes a curved tip extending past the nozzle orifice that operates as a retractor to manipulate tissue within the patient's mouth. Additionally, the suction is easily controlled by the user through manipulation of a port along the length of the instrument. In particular, a user can simply place a finger over the port when suction is desired and remove the finger from over the port when no suction is desired. Various embodiments of the instrument are shown in the figures and are described below.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a top view of the instrument, according to an exemplary embodiment;

FIG. 2 is a side view of the instrument of FIG. 1, according to an exemplary embodiment;

FIG. 3 is a view of the instrument looking down the instrument of FIGS. 1 and 2 from the first end towards the second end, according to an exemplary embodiment;

FIG. 4 is a top view of an instrument, according to another exemplary embodiment;

FIG. 5 is a side view of the instrument of FIG. 4, according to an exemplary embodiment;

FIG. 6 is a top view of the instrument of FIGS. 4 and 5 including a removable tip, according to an exemplary embodiment;

FIG. 7 is a side view of the instrument of FIGS. 4 and 5 including the removable tip, according to an exemplary embodiment;

FIG. 8 is a perspective view of the instrument in the form of an Austin retractor, according to an exemplary embodiment;

FIG. 9 is a perspective view of the instrument in the form of a Minnesota retractor, according to an exemplary embodiment; and

FIG. 10 depicts a view of a suction nozzle section having an angled orifice, according to an exemplary embodiment.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Embodiments of an instrument for retraction and suction during performance of an oral procedure are disclosed herein. In general, the instrument is profiled so as to operate as a retractor during use. Further, the instrument has a central passage and an end configured for attachment to a suction device. In this way, the instrument operates to provide suction for removal of, e.g., bone slurry, blood, saliva, debris, and irrigant, during an oral procedure. The suction is modulated using a port that remains uncovered when suction is not desired and that is covered by a user's finger when suction is desired. Embodiments of the instrument described herein are provided by way of example and not by limitation.

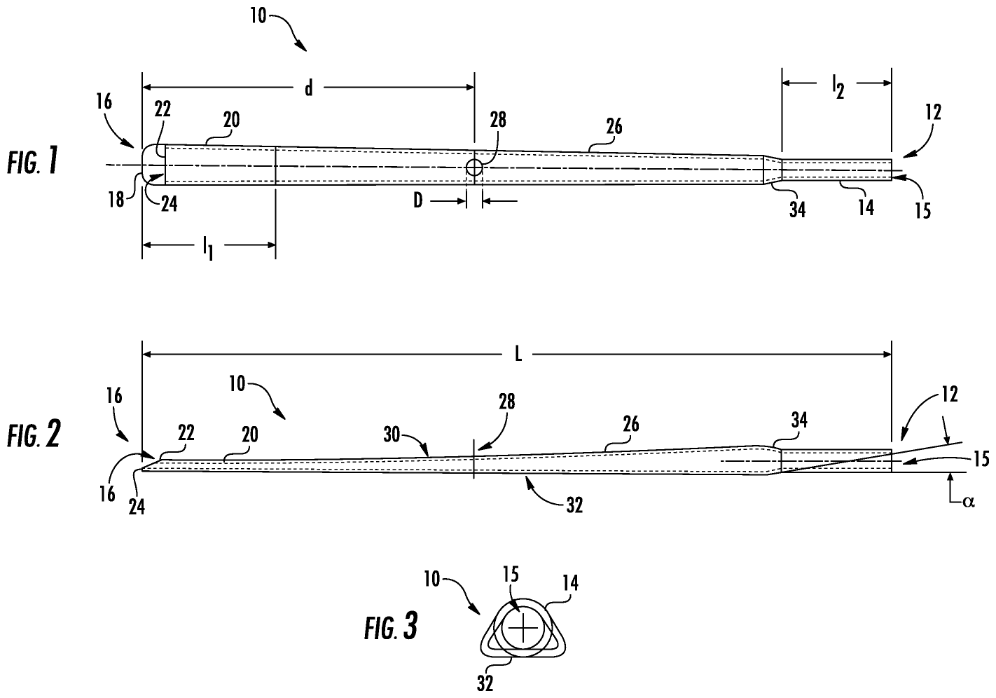

FIG. 1 depicts a top view of an instrument 10. At a first end 12 of the instrument 10 is an attachment section 14. The attachment section 14 is configured to connect to a suction device, such as a vacuum pump. In embodiments, attachment to the vacuum pump is facilitated via a length of tubing or hose that fits over the attachment section 14 so as to create a tight frictional engagement between the inner surface of the tubing and the outer surface of the attachment section 14. In the embodiment depicted, the attachment section 14 is cylindrical and defines a round opening 15 (as also shown in FIG. 3).

With reference to FIG. 1, at a second end 16 of the instrument 10 is a retractor tip 18 with a suction nozzle section 20. As can be seen, the retractor tip 18 is curved in shape and is configured to allow the user to retract tissue during an oral procedure. The retractor tip 18 leads into the suction nozzle section 20 that includes an orifice 22 defining a slot opening 24. A central conduit section 26 spans between the suction nozzle section 20 and the attachment section 14. The central conduit section 26 is hollow such that fluids/debris that enter the slot opening 24 are able to travel through the central conduit section 26 and out of the round opening 15 of the attachment section 14. The central conduit section 26 increases in width from a first, smaller width proximate the first end 12 to a second, wider width proximate the second end 16. After widening throughout the central conduit section 26 going from the first end 12 to the second end 16, the suction nozzle section 20 has a substantially constant width until reaching the curved retractor tip 18.

Disposed along the length of the central conduit section 26 is a port 28. During use of the instrument 10, the port 28 controls suction through the instrument 10 based on whether the user's finger covers the port 28. In particular, when a suction device is attached to the attachment section 14 and a vacuum is being drawn, port 28 controls whether the suction pressure is sufficient to draw fluids/debris through the instrument 10. When the port 28 is uncovered, the suction pressure at the orifice 22 is not sufficient to draw fluids/debris into the slot opening 24 (or at least very far through the suction nozzle section 20). When the port is covered, e.g., by the user's finger, the suction pressure at the slot opening 24 is high enough to draw fluids/debris through the length of the instrument 10 for removal by the suction device.

FIG. 2 depicts a side view of the instrument 10. As can be seen in FIG. 2, the instrument 10 has a first surface 30 oriented upwardly with respect to the orientation of FIG. 2 and a second surface 32 oriented downwardly with respect to the orientation of FIG. 2. The second surface 32 is substantially planar throughout the suction nozzle section 20 and the central conduit section 26. The first surface 30 in the suction nozzle section 20 is substantially parallel to the second surface 32, and in the central conduit section 26, the first surface 30 is angled relative to the second surface 32. In this way, the central conduit section 26 tapers from a first, greater thickness proximate the first end 12 to a second, lesser thickness proximate the second end 16. By tapering the thickness of the central conduit section 26 at the same time the width widens in the central conduit section 26, suction pressure is maintained or increased along the length of the instrument 10.

As can be seen in the embodiment shown in FIGS. 1 and 2, the thickness and width of the central conduit section 26 are greater than the thickness and width of the attachment section 14. Thus, a transition section 34 is provided to connect the central conduit section 26 to the attachment section 14. In embodiments, the transition section 34 tapers going from the central conduit section 26 to the attachment section 14 at an angle α of from 5° to 15°. In other embodiments, the transition section 34 tapers at an angle α of from 7° to 12°, and in still other embodiments, the transition section 34 tapers at an angle α of about 9°. As can be seen in FIG. 3, the instrument 10 has a generally triangular cross-section in a region along its length, which provides ergonomic gripping of the instrument 10.

In embodiments, the sections and elements of the instrument 10 are arranged in a position relative to other sections and elements of the instrument 10. As can be seen in the embodiment shown in FIGS. 1 and 2, the instrument 10 has an overall length L from the first end 12 to the second end 16. In embodiments, the length L is from 4″ to 12″, and in other embodiments, the length L is from 6″ to 10″.

In embodiments, the port 28 is positioned closer to the second end 16 than to the first end 12. In embodiments, the port 28 is positioned a distance d from the second end 16 such that (0.4)L≤d≤(0.5)L. In a specific embodiment, the instrument 10 has an overall length of 8.5″, and the port 28 is at a distance d of 3.75″ away from the second end 16.

In embodiments, the suction nozzle section 20 has a length l₁ such that l₁≤(0.2)L. In embodiments, the length l₁ of the suction nozzle section 20 is from 1″ to 2″. In a specific embodiment, the suction nozzle section 20 has a length l₁ of 1.5″.

In embodiments, the attachment section 14 has a length l₂ such that l₂≤(0.15)L. In embodiments, the length 12 of the attachment section 14 is from 0.5″ to 1.5″. In a specific embodiment, the attachment section 14 has a length l₂ of 1.25″.

In embodiments, the port 28 has a diameter D of from 0.1″ to 0.2″. In certain embodiments, the port 28 has a diameter D of from 0.15″ to 0.2″. In a specific embodiment, the port 28 has a diameter D of 0.188″.

In embodiments, the entire instrument 10 is of a single body construction. In embodiments, the instrument 10 is made of metal, such as stainless steel. In other embodiments, the instrument 10 is a ceramic material, a composite material, or a polymeric material. In other embodiments, the instrument 10 is comprised of at least two pieces. For example, in an embodiment, the attachment section 14 and the central conduit section 26 are a single piece, e.g., a stainless steel or other metal piece, and the suction nozzle section 20 is a separate piece, e.g., a disposable rubber piece or other soft polymeric material, that attaches to the other piece. In this way, a softer material is used for retracting tissue in the patient's mouth. In still another embodiment, the attachment section 14, the central conduit section 26, and the suction nozzle section 20 are all a single piece, and a rubber (or other soft polymeric material) cap is placed over at least a portion of the suction nozzle section 20 to provide a softer material for retracting tissue in the patient's mouth.

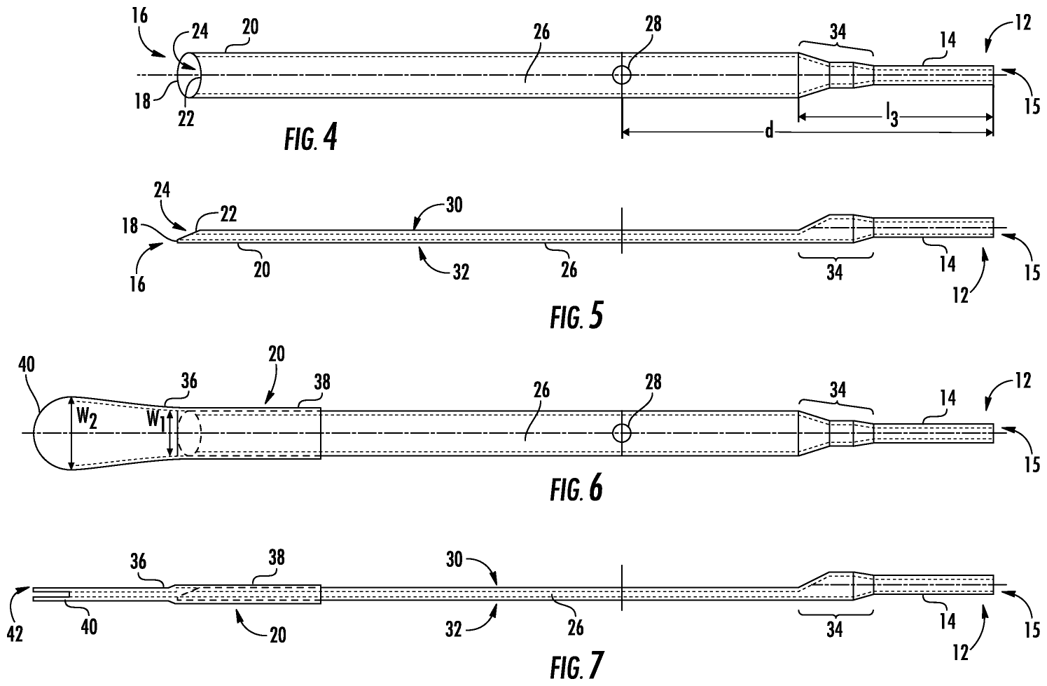

FIG. 4 depicts a top view of another embodiment of the instrument 10. At the first end 12 of the instrument 10 is the attachment section 14, which is configured to connect to a suction device, such as a vacuum pump. As with the previous embodiment, the attachment section 14 in the embodiment depicted is cylindrical and defines a round opening 15. At the second end 16 of the instrument 10 is the retractor tip 18 with the suction nozzle section 20. As can be seen, the retractor tip 18 is curved in shape and is configured to allow the user to retract tissue during an oral procedure. The retractor tip 18 leads into the suction nozzle section 20, including the orifice 22 defining the slot opening 24. The central conduit section 26 spans between the suction nozzle section 20 and the attachment section 14. As with the previous embodiment, the central conduit section 26 is hollow such that fluids/debris that enter the slot opening 24 are able to travel through the central conduit section 26 and out of the round opening 15 of the attachment section 14. In contrast to the previous embodiment, however, the central conduit section 26 has a constant width along its length. In particular, in the embodiment depicted, the central conduit section 26 has the same width as the suction nozzle section 20. Disposed along the length of the central conduit section 26 is the port 28. During use of the instrument 10, the port 28 controls suction through the instrument 10 based on whether the user's finger covers the port 28 for controlling suction pressure.

FIG. 5 depicts a side view of the instrument 10. As can be seen in FIG. 5, the instrument 10 has a first surface 30 oriented upwardly with respect to the orientation of FIG. 5 and a second surface 32 oriented downwardly with respect to the orientation of FIG. 5. In this embodiments, both the first surface 30 and the second surface 32 are substantially planar throughout the suction nozzle section 20 and the central conduit section 26. As can be seen in the embodiment shown in FIGS. 4 and 5, the transition section 34 is provided to connect the central conduit section 26 to the attachment section 14. In contrast to the previous embodiment, the port 28 is positioned closer to the first end 12 that to the second end 16. In embodiments, the port 28 is positioned a distance d from the first end 12 such that (0.4)L≤d≤(0.5)L. In a specific embodiment, the instrument 10 has an overall length of 8.5″, and the port 28 is at a distance d of about 3.75″ away from the second end 16. In embodiments, the attachment section 14 and transition section 34 have a combined length l₃ such that l₃≤(0.3)L. In embodiments, the combined length l₃ of the attachment section 14 and transition section 34 is from 1″ to 2.5″. In a specific embodiment, the attachment section 14 and transition section 34 have a combined length l₃ of 2″. As with the previous embodiment, the port 28 has a diameter D of from 0.1″ to 0.2″. In certain embodiments, the port 28 has a diameter D of from 0.15″ to 0.2″. In a specific embodiment, the port 28 has a diameter D of 0.188″.

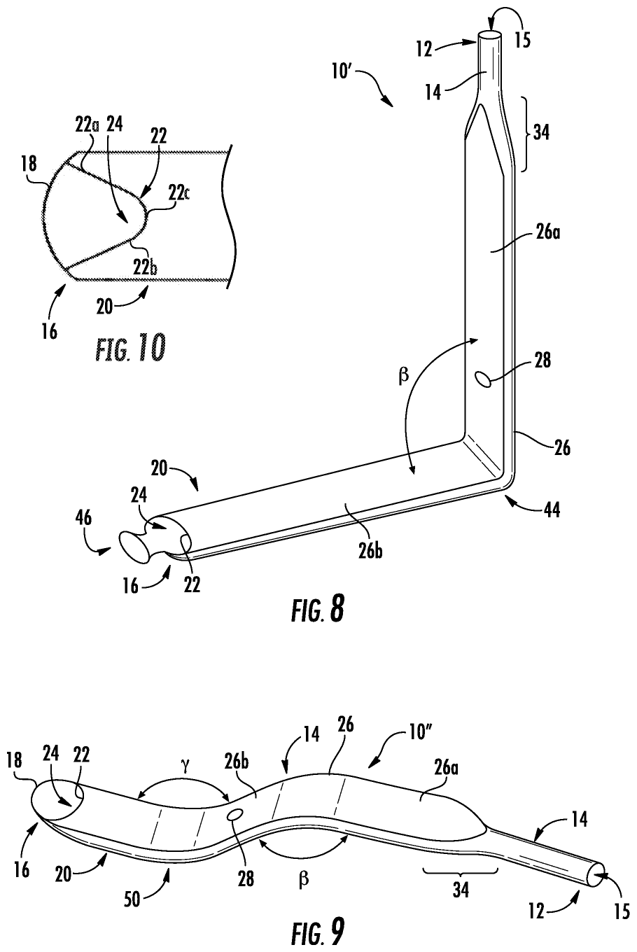

FIGS. 6 and 7 depict an embodiment of the instrument having a removable tip 36. While the removal tip 36 is shown associated with the embodiment of the instrument 10 shown in FIGS. 4 and 5, the removable tip 36 can be used or configured to be used with any of the embodiments depicted herein. As can be seen in FIG. 6, the removable tip 36 slides over at least a portion of the suction nozzle 20. In embodiments, the removable tip 38 has a first section 38 that provides a tight frictional engagement with the suction nozzle section 20, and thus, the first section 38 has an width that the same as the width of the suction nozzle section 20 or only slightly larger. In embodiments, the removable tip 36 includes a second section 40 that transitions from a first, smaller width W₁ to a second, larger width W₂. Upon widening to the section width W₂, the second section 40 terminates in a semicircular end. As shown in the side view of FIG. 7, the removable tip 36 includes a slot 42 to allow for saliva/debris to be suctioned through the instrument 10.

FIGS. 8 and 9 depict alternative embodiments of the instrument 10. In particular, FIG. 8 depicts an embodiment of an Austin retractor 10′. In the Austin retractor 10′ the central conduit section 26 is divided into a first portion 26a and a second portion 26b. The first portion 26a is angled relative to the second portion 26b such that a bend 44 is formed in the central conduit section 26. In embodiments, an angle β between the first portion 26a and the second portion 26b is from 70° to 110°, more particularly from 80° to 100° and most particularly about 85° to 95°. In the embodiment depicted in FIG. 8, the port 28 is provided on the first portion 26a, but in other embodiments, the port 28 is provided on the second portion 26b. Additionally, the suction nozzle section 20 terminates in a hook extension 46 that extends upwardly (with respect to the orientation of FIG. 8) from the suction nozzle section 20. The hook extension 46 is configured to grasp tissue to move it out of the desired field of vision.

FIG. 9 depicts an embodiment of a Minnesota retractor 10″. In the Minnesota retractor 10″, the central conduit section 26 is again divided into a first portion 26a and a second portion 26b, but in addition to angling the first portion 26a relative to the second portion 26b to create a first bend 44, the suction nozzle section 20 is also angled relative to the second portion 26b to create a second bend 50. In embodiments, the angle β between the first portion 26a and the second portion 26b is from 90° to 145°, more particularly from 100° to 130° and most particularly about 110° to 120°. In embodiments, an angle γ between the second portion 26b and the suction nozzle section 20 is also from 90° to 145°, more particularly from 100° to 130° and most particularly about 110° to 120°. In embodiments, the angles β and γ produce a zig-zag shape of the Minnesota retractor 10″. In embodiments, the suction nozzle section 20 is in a plane parallel to the plane of the first portion 26a. In the embodiment depicted, the port 28 is provided in the second portion 26a, but in other embodiments, the port 28 is provided in the first portion 26a.

In both the Austin retractor 10′ and the Minnesota retractor 10″, many features are shared in common with the embodiments depicted in FIGS. 1-7. In particular, an opening 15 in the attachment section 14 is provided at the first end 12, and a transition section 34 tapers from the central conduit section 26 to the attachment section 14. Additionally, at the second end 16, the second nozzle section 20 includes a retractor tip 18 and an orifice 22 defining a slot opening 24.

FIG. 10 depicts another embodiment of the retractor tip 18 and slot opening 24. As shown in FIG. 10, the retractor tip 18 at the second end 16 includes an angled orifice 22. The angled orifice 22 includes a first orifice side 22a and a second orifice side 22b connected by a rounded section 22c. In embodiments, the first orifice side 22a forms an angle with the second orifice side 22b of from 30° to 90°, more particularly from 45° to 75° and most particularly from 55° to 65°. Advantageously, the angled orifice 22 allows for less clogging and better suction of debris.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A suction retraction instrument for use in oral or dental procedures, the suction retraction instrument comprising:
an attachment section defining an opening at a first end;
a suction nozzle section defining a slot opening at a second end, the suction nozzle section including a retractor tip extending past the slot opening;
a central conduit section disposed between the attachment section and the suction nozzle section, the central conduit section providing fluid communication between the opening at the first end and the slot opening at the second end;
wherein the central conduit section includes a port configured to control suction pressure at the slot opening.

2. The suction retraction instrument of claim 1, wherein the central conduit section increases in width from a first, smaller width proximate to the first end to a second, wider width proximate the second end.

3. The suction retraction instrument of claim 2, wherein the suction nozzle section has a substantially constant width until reaching the retractor tip.

4. The suction retraction instrument of claim 1, further comprising a transition section connecting the central conduit section to the attachment section, wherein the transition section tapers going from the central conduit section to the attachment section.

5. The suction retraction instrument of claim 4, wherein the transition section tapers at an angle of from 5° to 15°.

6. The suction retraction instrument of claim 1, wherein the central conduit section has a triangular cross-section.

7. The suction retraction instrument of claim 1, wherein the suction retraction instrument has a length L and wherein the port is positioned a distance d from the second end such that (0.4)L≤d≤(0.5)L.

8. The suction retraction instrument of claim 1, wherein central conduit section has a first thickness proximate to the first end and a second thickness proximate to the second end, wherein the first thickness is greater than the second thickness, and wherein the central conduit section tapers from the first thickness to the second thickness.

9. The suction retraction instrument of claim 1, further comprising a removable tip having a first section and a second section, wherein the first section is configured to frictionally fit over the suction nozzle section and wherein the second section extends past the second end.

10. The suction retraction instrument of claim 9, wherein the removable tip terminates in a semicircular end, the semicircular end having a slot formed therein to provide fluid communication to the slot opening.

11. The suction retraction instrument of claim 10, wherein the second section of the removable tip transitions from a first width proximal to the first section of the removable tip to a second width proximal to the semicircular end of the removable tip, the second width being greater than the first width.

12. The suction retraction instrument of claim 1, wherein the central conduit section and the suction nozzle section have a constant width along a length of the suction retraction instrument until reaching the retractor tip.

13. The suction retraction instrument of claim 12, wherein the central conduit section and the suction nozzle section have a constant thickness along the length of the suction retraction instrument until reaching the slot opening.

14. The suction retraction instrument of claim 1, wherein the central conduit section comprises a first portion and a second portion and wherein the first portion is angled relative to the second portion.

15. The suction retraction instrument of claim 14, wherein the first portion forms a first angle with the second portion of from 70° to 110°.

16. The suction retraction instrument of claim 15, wherein the retractor tip includes a hook extension for manipulating tissue in a mount of a patient.

17. The suction retraction instrument of claim 14, wherein the second portion of the central conduit section is angled relative the suction nozzle section.

18. The suction retraction instrument of claim 17, wherein the first portion forms a first angle with the second portion of from 90° to 145°.

19. The suction retraction instrument of claim 18, wherein the second portion forms a second angle with the suction nozzle section of from 90° to 145° and wherein the first portion, the second portion, and the suction nozzle section define a zigzag shape.

20. A method of clearing at least one of fluid or debris from a mouth, comprising the steps of:
providing the suction retraction instrument of claim 1 with suction at the opening of the first end;
inserting the suction retraction instrument into the mouth;
manipulating tissue in the mouth using the retractor tip of the suction retraction instrument; and
placing a finger over the port of the suction retraction instrument to increase a suction pressure at the slot opening relative to the suction pressure at the slot opening when the finger is not placed over the port.
